(19) United States
(12) Patent Application Publication
(10) Pub. No.: US 2006/0286231 A1
(43) Pub. Date: Dec. 21, 2006

(54) Vegetable peeling assembly and method

(76) Inventor: Mark A. Speed, Grizzly Flats, CA (US)

Correspondence Address: SEAN KAUFHOLD, P. O. BOX 89626, SIOUX FALLS, SD, 57109, US

(21) Appl. No.: 11/144,451

(22) Filed: Jun. 6, 2005

(51) Int. Cl. A23P 1/00

(52) U.S. Cl. 426/478; 426/479; 426/481; 426/482; 426/483

(57) ABSTRACT

A vegetable peeling assembly includes a housing that has a bottom wall, a top wall and a peripheral wall. A motor is mounted in the housing. A shaft attached to the motor extends upwardly through the top wall. A container includes a lower wall and a perimeter wall that is attached to and extends upwardly from the lower wall. The lower wall is mounted on the top wall and the shaft extends upwardly through the lower wall. The perimeter wall has an inner surface. A plurality of raised members is positioned on the inner surface. The raised members are positioned adjacent to each other and form an abrasive surface. A disc has an upper surface and a lower surface. The lower surface is attached to the shaft. A plane of the disc is orientated perpendicular to a longitudinal axis of the shaft.

### BACKGROUND OF THE INVENTION

1. Field of the Invention

The present invention relates to peeling devices and more particularly pertains to a new peeling device for peeling the skins off of a vegetable and in particular a device for removing the skins from a plurality of potatoes.

2. Description of the Prior Art

The use of peeling devices is known in the prior art. U.S. Pat. No. 4,998,467 describes a device for removing skins from potatoes. Another type of peeling device is U.S. Pat. No. 5,662,034 and still yet another such device is found in U.S. Pat. No. 5,752,436.

While these devices fulfill their respective, particular objectives and requirements, the need remains for a device that can hold a plurality of potatoes and simultaneously peel the potatoes in a relatively short amount of time.

### SUMMARY OF THE INVENTION

The present invention meets the needs presented above by generally comprising a housing that has a bottom wall, a top wall and a peripheral wall that is attached to and extends between the top and bottom walls. A motor is mounted in the housing. A shaft is attached to the motor and extends upwardly through the top wall. The motor is configured to rotate the shaft when the motor is turned on. A container includes a lower wall and a perimeter wall that is attached to and extends upwardly from the lower wall. The lower wall is mounted on the top wall and the shaft extends upwardly through the lower wall. The perimeter wall has an inner surface. A plurality of raised members is positioned on the inner surface. The raised members are positioned adjacent to each other and form an abrasive surface. A disc has an upper surface and a lower surface. The lower surface is attached to the shaft. A plane of the disc is orientated perpendicular to a longitudinal axis of the shaft. A plurality of vegetables is positioned in the container. The motor is turned on so that the motor rotates the disc. The vegetables are tumbled within the container by the disc and strike the inner surface until outer skins of the vegetables are removed.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a vegetable peeling assembly and method according to the present invention.

FIG. 2 is a cross-sectional view of a container of the present invention.

FIG. 3 is a top view of a disc of the present invention.

FIG. 4 is a top view of a slicing member of the present invention.

FIG. 5 is a schematic view of the present invention.

### DESCRIPTION OF THE PREFERRED EMBODIMENT

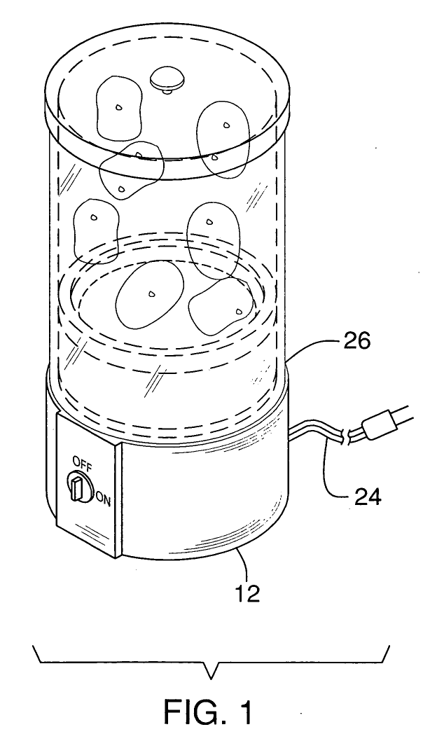

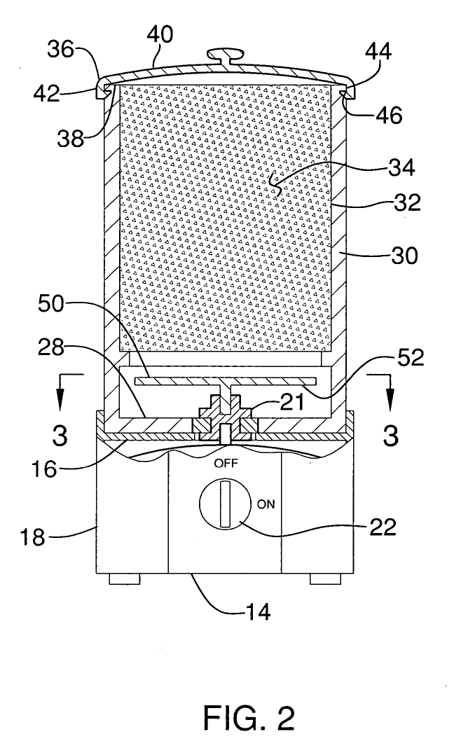

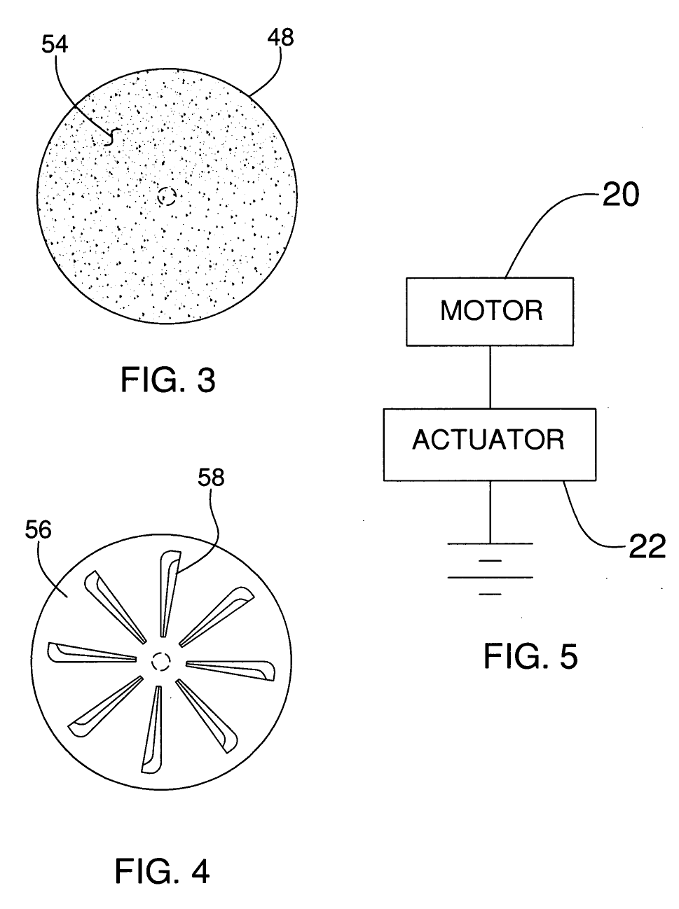

With reference now to the drawings, and in particular to FIGS. 1 through 5 thereof, a new peeling device embodying the principles and concepts of the present invention and generally designated by the reference numeral 10 will be described.

As best illustrated in FIGS. 1 through 5, the vegetable peeling assembly and method 10 generally comprises a housing 12 that has a bottom wall 14, a top wall 16, and a peripheral wall 18 that is attached to and extends between the top 16 and bottom 14 walls. A motor 20 is mounted in the housing 12. A shaft 21 is attached to the motor 20 and extends upwardly through the top wall 16. The motor 20 is configured to rotate the shaft 21 when the motor 20 is turned on. An actuator 22 is operationally coupled to the motor 20 for selectively turning motor on or off. The motor 20 may include a variable speed motor. An electrical cord 24 is electrically coupled to the motor 20 and may be plugged into a standard electrical outlet to supply electrical power to the motor 20.

A container 26 includes a lower wall 28 and a perimeter wall 30 that is attached to and extends upwardly from the lower wall 28. The lower wall 28 is mounted on the top wall 16 and the shaft 21 extends upwardly through the lower wall 28. The perimeter wall 30 has an inner surface 32. A plurality of raised members 34 is positioned on the inner surface 32. The raised members 34 are positioned adjacent to each other and form an abrasive surface or covering on the inner surface 32. The raised members 34 are preferably non-arcuate and are angular in nature. A cover 36 is removably positioned on an upper edge 38 of the perimeter wall 30. The cover 36 includes an upper wall 40 and a perimeter lip 42 is attached to and extending downwardly from the upper wall 40. A perimeter flange 44 is attached to the lip 42 and extends inwardly from the lip 42. The perimeter wall 30 has a perimeter groove 46 therein positioned adjacent to the upper edge 38. The flange 44 is snappily positionable in the groove 46 to releasably secure the cover 36 to the container 26.

A disc 48 has an upper surface 50 and a lower surface 52. The lower surface 52 is attached to the shaft 21. A plane of the disc 48 is orientated perpendicular to a longitudinal axis of the shaft 21. The upper surface 50 has a plurality of indentations 54 therein. A cutting member 56 may also be included which includes a plurality of blades 48 for slicing vegetables. The disc 48 may be replaced with the cutting disc 56 as needed.

In use, a plurality of vegetables is positioned in the container 26. In particular, the vegetables are potatoes, though other respectively rigid vegetables may also be placed in the container. The cover 36 is placed on container 26 and the motor 20 is turned on. The rotating disc 48 causes the vegetables to tumble within the container 26. As they tumble, they strike the inner surface 32 of the perimeter wall 30 and the raised members 34 remove the outer skins from the vegetables. Once the skins have been removed, the motor 20 is turned off and the vegetables removed from the container 26.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of peeling vegetables, said method comprising the steps of:
providing a housing having a bottom wall, a top wall, and a peripheral wall being attached to and extending between said top and bottom walls, a motor being mounted in said housing, a shaft being attached to said motor and extending upwardly through said top wall, said motor being configured to rotate said shaft when said motor is turned on;
providing a container including a lower wall and a perimeter wall being attached to and extending upwardly from said lower wall, said lower wall being mounted on said top wall and said shaft extending upwardly through said lower wall, said perimeter wall having an inner surface, a plurality of raised members being positioned on said inner surface, said raised members being positioned adjacent to each other and forming an abrasive surface;
providing a disc having an upper surface and a lower surface, said lower surface being attached to said shaft, a plane of said disc being orientated perpendicular to a longitudinal axis of said shaft;
positioning a plurality of vegetables in said container;
turning on said motor such that said motor rotates said disc; and
tumbling of said vegetables within said container by said disc and striking said vegetables off of said inner surface until outer skins of said vegetables are removed.

2. The method according to claim 1, further providing a cover being removably positioned on an upper edge of said perimeter wall and positioning said cover on and covering said container with said cover after the vegetables have been positioned in said container.

3. The method according to claim 2, wherein said cover includes an upper wall and a perimeter lip being attached to and extending downwardly from said upper wall, a perimeter flange being attached to said lip and extending inwardly from said lip, said perimeter wall having a perimeter groove therein positioned adjacent to said upper edge, said flange being snappily positionable in said groove and releasably securing said cover to said container.

4. The method according to claim 1, wherein said upper surface of said disc has a plurality of indentations therein.

5. A method of peeling vegetables, said method comprising the steps of:
providing a housing having a bottom wall, a top wall and a peripheral wall being attached to and extending between said top and bottom walls, a motor being mounted in said housing, a shaft being attached to said motor and extending upwardly through said top wall, said motor being configured to rotate said shaft when said motor is turned on, an actuator being operationally coupled to said motor for selectively turning motor on or off;
providing a container including a lower wall and a perimeter wall being attached to and extending upwardly from said lower wall, said lower wall being mounted on said top wall and said shaft extending upwardly through said lower wall, said perimeter wall having an inner surface, a plurality of raised members being positioned on said inner surface, said raised members being positioned adjacent to each other and forming an abrasive surface, a cover being removably positioned on an upper edge of said perimeter wall, said cover including an upper wall and a perimeter lip being attached to and extending downwardly from said upper wall, a perimeter flange being attached to said lip and extending inwardly from said lip, said perimeter wall having a perimeter groove therein positioned adjacent to said upper edge, said flange being snappily positionable in said groove and releasably securing said cover to said container;
providing a disc having an upper surface and a lower surface, said lower surface being attached to said shaft, a plane of said disc being orientated perpendicular to a longitudinal axis of said shaft, said upper surface having a plurality of indentations therein;
positioning a plurality of vegetables in said container;
covering said container with said cover;
turning on said motor such that said motor rotates said disc; and
tumbling of said vegetables within said container by said disc and striking said vegetables off of said inner surface until outer skins of said vegetables are removed.
